(19) United States
(12) Patent Application Publication
(10) Pub. No.: US 2011/0102540 A1
(43) Pub. Date: May 5, 2011

(54) Filtering Auxiliary Audio from Vocal Audio in a Conference

(76) Inventors: Ashish Goyal, Bangalore (IN); Sunil George, Bangalore (IN); Raphael Anuar, Austin, TX (US); Beau C. Chimene, Austin, TX (US)

(21) Appl. No.: 12/905,148

(22) Filed: Oct. 15, 2010

Related U.S. Application Data
(60) Provisional application No. 61/257,592, filed on Nov. 3, 2009.

(51) Int. Cl. H04N 7/15

(52) U.S. Cl. 348/14.08; 348/E07.083

(57) ABSTRACT

Filtering auxiliary audio from vocal audio in a conference. Audio may be received during a conference. The audio may include vocal audio from a first participant as well as auxiliary audio that is not vocal audio from the first participant. The auxiliary audio may result from use of a computer input device at the location. The audio may be filtered to remove the auxiliary audio from the audio. The filtered audio may be provided, e.g., over a network to other participant locations of the conference.

### PRIORITY DATA

This application claims benefit of priority of U.S. provisional application Ser. No. 61/257,592 titled “Filtering Auxiliary Audio from Vocal Audio” filed Nov. 3, 2009, whose inventors were Ashish Goyal, Sunil George, Raphael Anuar, and Beau C. Chimene, which is hereby incorporated by reference in its entirety as though fully and completely set forth herein.

### FIELD OF THE INVENTION

The present invention relates generally to conferencing and, more specifically, to a method for filtering auxiliary audio from vocal audio in a conference.

### DESCRIPTION OF THE RELATED ART

Videoconferencing may be used to allow two or more participants at remote locations to communicate using both video and audio. Each participant location may include a videoconferencing system for video/audio communication with other participants. Each videoconferencing system may include a camera and microphone to receive video and audio from a first or local participant to send to another (remote) participant. Each videoconferencing system may also include a display and speaker(s) to reproduce video and audio received from one or more remote participants. Each videoconferencing system may also be coupled to (or comprise) a computer system to allow additional functionality into the videoconference. For example, additional functionality may include data conferencing (including displaying and/or modifying a document for both participants during the conference).

Similarly, audioconferencing (e.g., teleconferencing) may allow two or more participants at remote locations to communicate using audio. For example, a speakerphone may be placed in a conference room at one location, thereby allowing any users in the conference room to participate in the audioconference with another set of user(s) (e.g., in another conference room with a speakerphone).

During conferences using current conferencing systems, participants may wish to use input devices, such as a keyboard, while participating in the conference. However, the noise from the input devices can be distracting. One prior system, described in U.S. Publication 2008/0279366, titled “Method and Apparatus for Automatically Suppressing Computer Keyboard Noises in Audio Telecommunication Session, filed May 8, 2007, describes muting a participant's audio when a keyboard is used. However, this prior method does not allow a participant to both use his input device and participate in the conference at the same time. Correspondingly, improvements in conferencing systems are desired.

### SUMMARY OF THE INVENTION

Various embodiments are presented of a system and method for filtering auxiliary audio from vocal audio in a conference.

A conference (e.g., a videoconference) may be initiated between a plurality of participants, including a first participant at a first location and a second participant at a second location.

During the conference, audio may be received. The audio may include vocal audio from the first participant as well as auxiliary audio that is not vocal. The audio may be received locally, e.g., by a conferencing unit at the first location, or may be received remotely, e.g., provided over a network to a conferencing unit at the second location.

In some embodiments, the auxiliary audio may result from use of a computer input device at the location. For example, the computer input device may be a computer keyboard or a computer mouse, among other possibilities, such as touchscreens.

The method may include determining that the audio comprises the auxiliary audio. For example, the method may analyze the frequency components of the audio to make this determination. Alternatively, the method may compare the received audio to prerecorded auxiliary audio to determine if the audio includes the auxiliary audio. In some embodiments, the prerecorded auxiliary audio may be specific to the computer input device used by the participant, although it may be generic or non-specific (e.g., corresponding to the type of input device used by the participant), as desired.

The auxiliary audio may be filtered from the audio. More specifically, the method may filter the audio to remove the auxiliary audio from the received audio, which produces filtered audio. The filtering may be performed automatically, e.g., without any determination of whether the audio comprises the auxiliary audio. Alternatively, the audio may be filtered based on the determination described above. In some embodiments, the filter may be adaptive, i.e., the filter may change how or when the auxiliary audio is filtered based on the received audio content (e.g., based on changes in the received audio content).

The reception, determination, and filtration described above may be performed by any of a plurality of devices or computer systems. For example, the method may be performed by the conferencing unit at the first location, a multipoint control unit (e.g., interposed between the first and second conferencing units), and/or the conferencing unit at the second location, as desired. Accordingly, the filtered audio may be provided to its destination, e.g., from the conferencing unit of the first participant and/or from the conferencing unit of the second participant, depending on where the method is performed.

In some embodiments, the method (e.g., the filtering) may be performed in response to input from a participant (e.g., the first participant and/or the second participant) requesting that the auxiliary audio be filtered. Thus, the input may indicate to the system that the first participant is intending to provide vocal audio (e.g., spoken words) and use the computer input device at the same time.

### BRIEF DESCRIPTION OF THE DRAWINGS

A better understanding of the present invention may be obtained when the following detailed description is considered in conjunction with the following drawings, in which:

FIGS. 1 and 2 illustrate exemplary videoconferencing system participant locations, according to an embodiment;

FIGS. 3A and 3B illustrate exemplary conferencing systems coupled in different configurations, according to some embodiments; and

FIG. 4 is a flowchart diagram illustrating an exemplary method for filtering auxiliary audio from vocal audio in a conference, according to an embodiment.

While the invention is susceptible to various modifications and alternative forms, specific embodiments thereof are shown by way of example in the drawings and will herein be described in detail. It should be understood, however, that the drawings and detailed description thereto are not intended to limit the invention to the particular form disclosed, but on the contrary, the intention is to cover all modifications, equivalents, and alternatives falling within the spirit and scope of the present invention as defined by the appended claims. Note that the headings are for organizational purposes only and are not meant to be used to limit or interpret the description or claims. Furthermore, note that the word “may” is used throughout this application in a permissive sense (i.e., having the potential to, being able to), not a mandatory sense (i.e., must). The term “include”, and derivations thereof, mean “including, but not limited to”. The term “coupled” means “directly or indirectly connected”.

### DETAILED DESCRIPTION OF THE EMBODIMENTS

### Incorporation by Reference

U.S. patent application titled “Video Conferencing System Transcoder”, Ser. No. 11/252,238, which was filed Oct. 17, 2005, whose inventors are Michael L. Kenoyer and Michael V. Jenkins, is hereby incorporated by reference in its entirety as though fully and completely set forth herein.

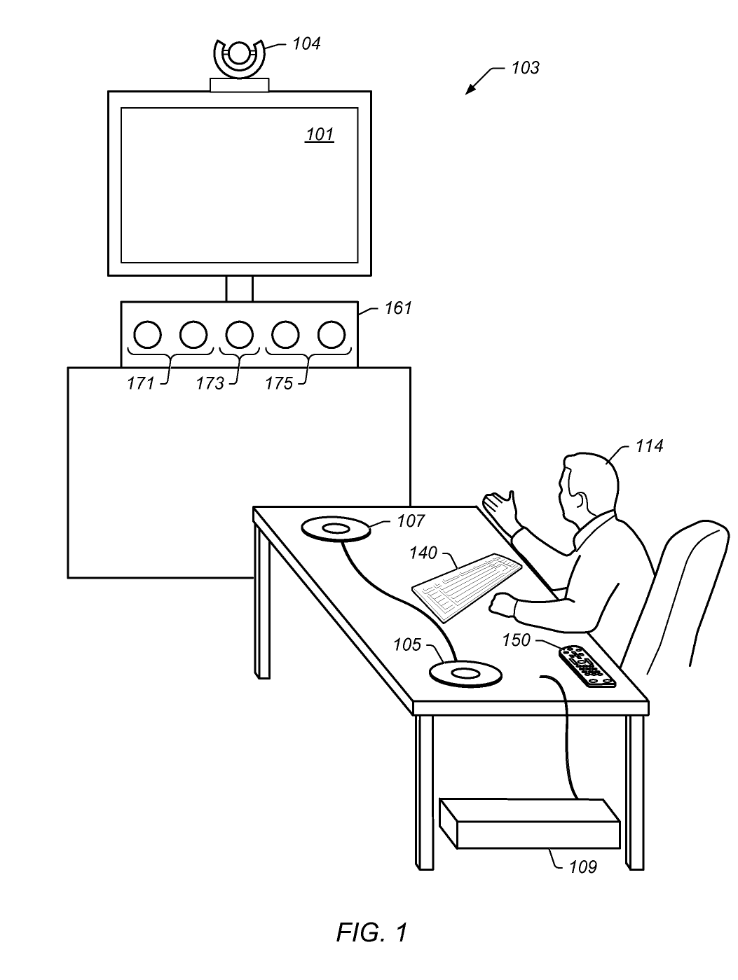

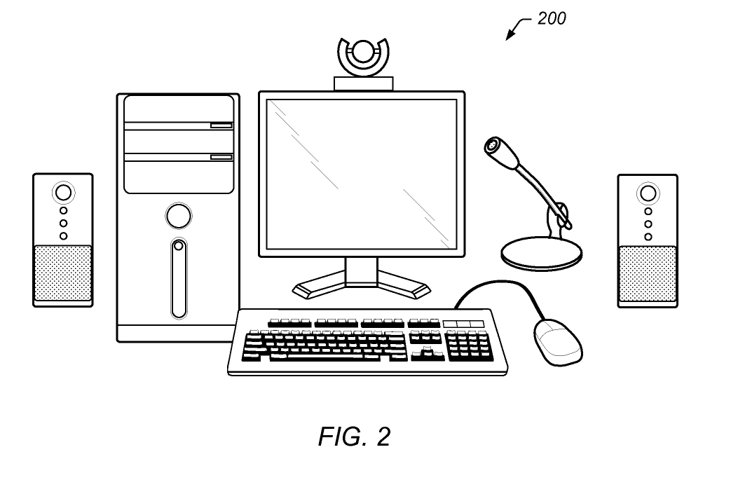

### FIGS. 1 and 2—Exemplary Participant Locations

FIG. 1 illustrates an exemplary embodiment of a videoconferencing participant location, also referred to as a videoconferencing endpoint or videoconferencing system (or videoconferencing unit). The videoconferencing system 103 may have a system codec 109 to manage both a speakerphone 105/107 and videoconferencing hardware, e.g., camera 104, display 101, speakers 171, 173, 175, etc. The speakerphones 105/107 and other videoconferencing system components may be coupled to the codec 109 and may receive audio and/or video signals from the system codec 109.

In some embodiments, the participant location may include camera 104 (e.g., an HD camera) for acquiring images (e.g., of participant 114) of the participant location. Other cameras are also contemplated. The participant location may also include display 101 (e.g., an HDTV display). Images acquired by the camera 104 may be displayed locally on the display 101 and/or may be encoded and transmitted to other participant locations in the videoconference.

The participant location may further include one or more input devices, such as the computer keyboard 140. In some embodiments, the one or more input devices may be used for the videoconferencing system 103 and/or may be used for one or more other computer systems at the participant location, as desired.

The participant location may also include a sound system 161. The sound system 161 may include multiple speakers including left speakers 171, center speaker 173, and right speakers 175. Other numbers of speakers and other speaker configurations may also be used. The videoconferencing system 103 may also use one or more speakerphones 105/107 which may be daisy chained together.

In some embodiments, the videoconferencing system components (e.g., the camera 104, display 101, sound system 161, and speakerphones 105/107) may be coupled to a system codec 109. The system codec 109 may be placed on a desk or on a floor. Other placements are also contemplated. The system codec 109 may receive audio and/or video data from a network, such as a LAN (local area network) or the Internet. The system codec 109 may send the audio to the speakerphone 105/107 and/or sound system 161 and the video to the display 101. The received video may be HD video that is displayed on the HD display. The system codec 109 may also receive video data from the camera 104 and audio data from the speakerphones 105/107 and transmit the video and/or audio data over the network to another conferencing system. The conferencing system may be controlled by a participant or user through the user input components (e.g., buttons) on the speakerphones 105/107 and/or input devices such as the keyboard 140 and/or the remote control 150. Other system interfaces may also be used.

In various embodiments, a codec may implement a real time transmission protocol. In some embodiments, a codec (which may be short for “compressor/decompressor”) may comprise any system and/or method for encoding and/or decoding (e.g., compressing and decompressing) data (e.g., audio and/or video data). For example, communication applications may use codecs for encoding video and audio for transmission across networks, including compression and packetization. Codecs may also be used to convert an analog signal to a digital signal for transmitting over various digital networks (e.g., network, PSTN, the Internet, etc.) and to convert a received digital signal to an analog signal. In various embodiments, codecs may be implemented in software, hardware, or a combination of both. Some codecs for computer video and/or audio may include MPEG, Indeo™, and Cinepak™, among others.

In some embodiments, the videoconferencing system 103 may be designed to operate with normal display or high definition (HD) display capabilities. The videoconferencing system 103 may operate with a network infrastructures that support T1 capabilities or less, e.g., 1.5 mega-bits per second or less in one embodiment, and 2 mega-bits per second in other embodiments.

Note that the videoconferencing system(s) described herein may be dedicated videoconferencing systems (i.e., whose purpose is to provide videoconferencing) or general purpose computers (e.g., IBM-compatible PC, Mac, etc.) executing videoconferencing software (e.g., a general purpose computer for using user applications, one of which performs videoconferencing). A dedicated videoconferencing system may be designed specifically for videoconferencing, and is not used as a general purpose computing platform; for example, the dedicated videoconferencing system may execute an operating system which may be typically streamlined (or “locked down”) to run one or more applications to provide videoconferencing, e.g., for a conference room of a company. In other embodiments, the videoconferencing system may be a general use computer (e.g., a typical computer system which may be used by the general public or a high end computer system used by corporations) which can execute a plurality of third party applications, one of which provides videoconferencing capabilities. Videoconferencing systems may be complex (such as the videoconferencing system shown in FIG. 1) or simple (e.g., a user computer system 200 with a video camera, input devices, microphone and/or speakers such as the videoconferencing system of FIG. 2). Thus, references to videoconferencing systems, endpoints, etc. herein may refer to general computer systems which execute videoconferencing applications or dedicated videoconferencing systems. Note further that references to the videoconferencing systems performing actions may refer to the videoconferencing application(s) executed by the videoconferencing systems performing the actions (i.e., being executed to perform the actions).

The videoconferencing system 103 may execute various videoconferencing application software that presents a graphical user interface (GUI) on the display 101. The GUI may be used to present an address book, contact list, list of previous callees (call list) and/or other information indicating other videoconferencing systems that the user may desire to call to conduct a videoconference.

Note that the videoconferencing system shown in FIGS. 1 and 2 may be modified to be an audioconferencing system. The audioconferencing system, for example, may simply include speakerphones 105/107, although additional components may also be present. Additionally, note that any reference to a “conferencing system” or “conferencing systems” may refer to videoconferencing systems or audioconferencing systems (e.g., teleconferencing systems).

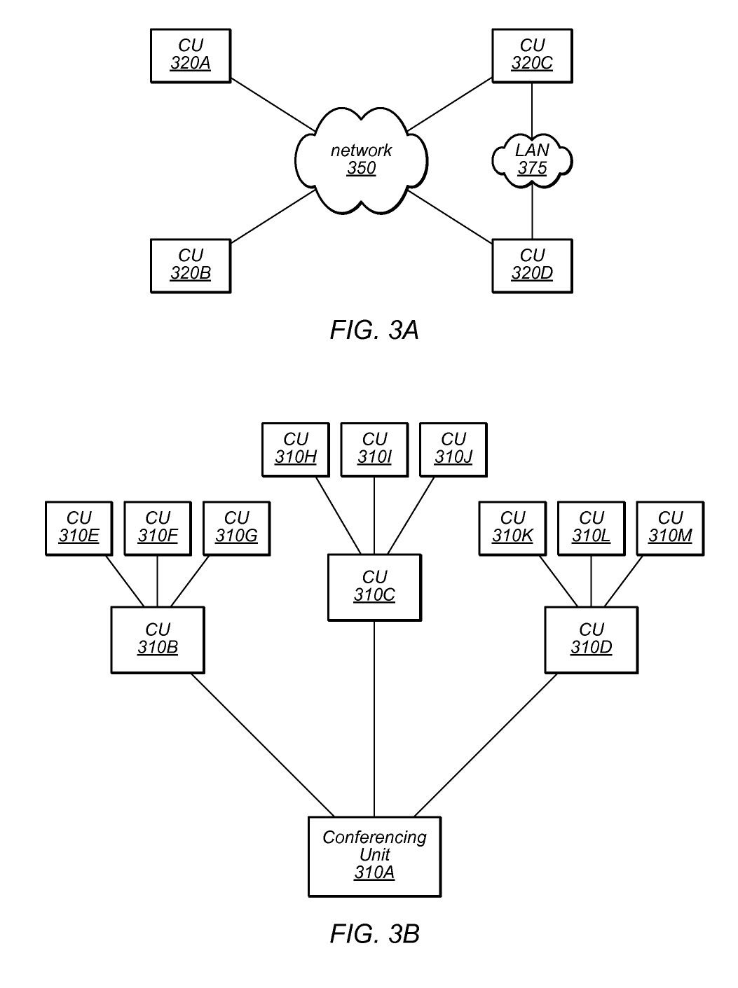

### FIGS. 3A and 3B—Coupled Conferencing Systems

FIGS. 3A and 3B illustrate different configurations of conferencing systems. The conferencing systems may be operable to perform the methods described herein. As shown in FIG. 3A, conferencing systems (CUs) 320A-D (e.g., videoconferencing systems 103 described above) may be connected via network 350 (e.g., a wide area network such as the Internet) and CU 320C and 320D may be coupled over a local area network (LAN) 375. The networks may be any type of network (e.g., wired or wireless) as desired.

FIG. 3B illustrates a relationship view of conferencing systems 310A-310M. As shown, conferencing system 310A may be aware of CU 310B-310D, each of which may be aware of further CU's (310E-310G, 310H-310J, and 310K-310M respectively). CU 310A may be operable to perform the methods described herein. In a similar manner, each of the other CUs shown in FIG. 3B, such as CU 310H, may be able to perform the methods described herein, as described in more detail below. Similar remarks apply to CUs 320A-D in FIG. 3A.

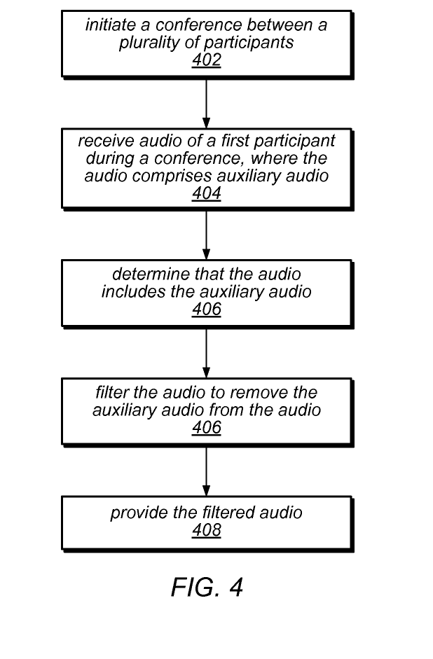

FIG. 4—Filtering Auxiliary Audio from Vocal Audio in a Conference

FIG. 4 illustrates a method for filtering auxiliary audio from vocal audio in a conference. The method shown in FIG. 4 may be used in conjunction with any of the computer systems or devices shown in the above Figures, among other devices. In various embodiments, some of the method elements shown may be performed concurrently, performed in a different order than shown, or omitted. Additional method elements may also be performed as desired. As shown, this method may operate as follows.

In 402, a conference may be initiated between a plurality of participants. More specifically, the conference may be initiated between a first participant at a first location and a second participant at a second location, although further participants and locations are envisioned. Each participant location has a respective conferencing unit, such as those described above regarding FIGS. 1 and 2. As indicated above, the conference may be an audioconference, such as a teleconference, where at least a subset or all of the participants are called using telephone numbers. Alternatively, the audioconference could be performed over a network, e.g., the Internet, using VoIP. Similarly, the conference may be a videoconference, and the videoconference may be established according to any of a variety of methods, e.g., the one described in patent application Ser. No. 11/252,238, which was incorporated by reference above. The videoconference or audioconference may utilize an instant messaging service or videoconferencing service over the Internet, as desired.

In 404, audio of the first participant may be received during a conference. The audio may include vocal audio from various participants in the conference. The audio may also include auxiliary audio. As used herein, the term “auxiliary audio” refers to audio that is not desired to be a part of the conference. Exemplary auxiliary audio includes audio provided from the use of input device(s) such as keyboards, mice, or touchscreens, background noise from a participant's location, incidental noises such as bangs or scratches, notification sounds (e.g., new email sounds, warning sounds, etc.), other computer sounds, and/or other types of noises (e.g., closing doors, drawers, etc.). The auxiliary audio could further include audio from the participant, such as coughs or grunts, chewing noises (e.g., from potato chips), etc., which is not desired to be a part of the conference. Thus, the audio of the first participant may include auxiliary audio that is not desired to be a part of the conference.

The audio may generally include vocal audio combined with auxiliary audio, although this may not always be the case. For example, during a certain period of time the audio may include only auxiliary audio, e.g., where a participant is using an input device, such as a keyboard, that makes typing or “clicking” sounds, and none of the participants are speaking during this time. Alternatively, during a different period of time the audio may include both vocal audio and auxiliary audio. As an example, auxiliary audio may originate from a participant using an input device, such as a keyboard, wherein this participant (or other participants at the same endpoint location) is also speaking at the same time. Thus, the audio may include desirable vocal audio and also include undesirable auxiliary audio.

The audio may be received locally, e.g., by a conferencing unit at the first location of the first participant, and/or may be received remotely, e.g., by a conferencing unit at the second location of the second participant. Thus, in the local embodiment, at the first participant location, the audio may be received from an input device, such as a microphone. However, in the remote embodiment, at the second participant location, the audio may be received over a network, e.g., from the conferencing unit of the first participant.

In 406, the method may determine that the audio includes the auxiliary audio. For example, in one embodiment, the audio may be compared to prerecorded auxiliary audio, e.g., samples, to determine if the prerecorded auxiliary audio is in the audio. In some embodiments, the prerecorded auxiliary audio may have been provided with the conferencing unit, and may thus be generic or non-specific prerecorded auxiliary audio. For example, the prerecorded auxiliary audio may include typing sounds from various types of input devices, such as keyboards, mice, etc. However, in other embodiments, the prerecorded auxiliary audio may be specific to the first location, e.g., specific to input devices at the first location. For example, during a configuration or calibration process, e.g., an initial configuration (or possibly at other times), the audio generated by various devices or objects may be recorded for later filtering. In one specific example, the specific audio generated by an input device of the participant, such as a keyboard, may be recorded so that auxiliary audio from that device can be filtered at a later time. Thus, in some embodiments, the auxiliary audio may be filtered with or without prior training to specific auxiliary audio.

Additionally, or alternatively, the audio may simply be analyzed to determine if specific types of auxiliary audio is present in the audio, e.g., without using prerecorded samples. For example, an analytic method or algorithm may be used to determine if keyboard sounds (e.g., clicks or presses) are present within the audio. Thus, the method may determine that the audio includes the auxiliary audio and may determine the type of the auxiliary audio and/or the specific frequencies of the auxiliary audio for filtering.

In one embodiment, the method may actually determine if desired audio is present (e.g., if the first participant or other participants at the first location are speaking) The determination of desired audio may also be based on prerecorded samples (e.g., specific to a participant or general prerecorded vocal samples). In other embodiments, the determination of desired audio may be based on algorithms or processes which are able to detect spoken audio from an audio spectrum. If the desired audio is not present, the method may assume that all present noises are auxiliary in nature. For example, if a participant is not speaking, but is instead using a computer input device, such as a keyboard, the noises from the keyboard may be determined to be auxiliary in nature (e.g., since they are not vocal). Accordingly, the audio may not be provided from the participant (since it has been determined to be auxiliary) or may at least be filtered, so that other participants do not hear the undesired auxiliary audio. Additionally, the auxiliary audio may be saved or otherwise analyzed for future determinations of auxiliary audio (e.g., even when desired audio is also present). Thus, background noise or input noise (among other types of auxiliary audio) may be detected when the desired audio is not present.

In a similar fashion, a background recording may be taken, possibly during a “silence” of the conference or at a particular participant location. This type of auxiliary detection may be performed during the conference (e.g., when the conference is at a low volume or quiet point), before the conference was started, and/or at other times, as desired. The background recording may be used as a basis for the filtering described in 408 below. For example, if the background recording includes a hum (e.g., from electronic equipment at one or more of the locations), the filtering in 408 may remove that hum by filtering the background noise from the audio. Similar to descriptions above, the auxiliary audio from input devices may be detected and characterized for later filtering in 408 below.

In 406, the method may also determine auxiliary audio characteristics which may be used to filter out the auxiliary audio from the received audio. For example, the auxiliary audio may be identified and characterized (e.g., by frequency, duration, etc.) in such a manner to allow the auxiliary audio to be filtered from the audio, e.g., even in the presence of desired or vocal audio. As one specific example, typing on a keyboard may periodically induce audio spikes at a specific audio frequency range. Accordingly, the specific frequency range may be identified as a characteristic of that auxiliary audio, and may be used for later removal. Other characteristics could also be determined, e.g., the height and length of the audio spike, which could be filtered out using other means (e.g., compressors).

In 408, the audio may be filtered or otherwise modified to remove the auxiliary audio from the audio. The filtering may be performed based on the determination of the auxiliary audio in 406. Additionally, the filtering may be based on identified characteristics of the auxiliary audio, which may have been determined in 406 above. For example, where a specific frequency range defines the auxiliary audio, then the frequency range may be filtered from the audio to remove the auxiliary audio. In some embodiments, where the frequency range overlaps with desired audio, such as vocal audio, only the portion of the frequency range that is outside of the desired range may be removed so as to preserve the quality of the desired audio. However, in alternate embodiments, the overlapping portion may still be removed to ensure that the distracting auxiliary audio is removed completely.

In further embodiments, it may be ensured that a threshold percentage of the desired audio is kept (e.g., of the main body of the desired audio) during the filtering. For example, rather than a strict removal of all overlapping or non-overlapping portion of the desired audio and auxiliary audio, the auxiliary audio may be filtered in a manner that at least keeps a threshold percentage (e.g., 80%, 50%, or similar values) of the desired audio in the resulting audio so that the desired audio is still understandable or perceivable.

While the above process may apply to embodiments where the determining is performed during the videoconference (e.g., dynamically or “on the fly”), it should be noted that the determinations in 406 may not be performed during the conference. For example, such determinations may have been performed prior to initiating the conference in 402 (e.g., in configuring the conferencing units). Accordingly, it may not be necessary to determine whether the audio includes the auxiliary audio at all, but instead, algorithms or processes may have already been developed which remove most or all of auxiliary audio without requiring such a determination. In such cases, the audio may be filtered in 408 according to these algorithms or processes without performing the determination described in 406 above.

In further embodiments, any background auxiliary audio may be filtered from the audio, as indicated above. For example, a background recording may have been taken, e.g., before the conference was started or at other times, such as when the conference is at a low volume or quiet point. In some embodiments, instead of specifically filtering the determined auxiliary audio from the audio, the method may simply filter everything but the desired audio (e.g., the entirety of the desired audio or a percentage of the desired audio, as desired). In these embodiments, rather than determining the presence or characteristics of the auxiliary audio, the method may determine the characteristics of the desired audio and filter the audio to remove all extraneous audio other than the desired audio.

In some embodiments, the determination (and correspondingly, the filtering described below) may be adaptive. For example, an adaptive filter may be used to determine the auxiliary audio and/or filter out the auxiliary audio, in 406 and 408. Thus, the determination of the auxiliary audio may change over time, e.g., during the videoconference, in response to the content of the received audio. For example, as the participant, for example, types on the keyboard in a different manner (e.g., more lightly or harder, or using a different portion of the keyboard, such as the number pad), the filter may adapt to the changing sounds of the keyboard and still effectively filter out the changing sounds generated by the participant's use of the keyboard. This also applies to other input devices and auxiliary audio.

In 410, the filtered audio may be provided. According to various embodiments, the filtered audio may be provided from the first conferencing unit of the first participant to the other participants over a network (e.g., where the method is performed locally) or may be provided from the second conferencing unit (or other conferencing unit) to the second participant (or other participant), e.g., where the method is performed remotely. Thus, the method may be performed before sending audio out to other conferencing units and/or may be performed after the audio is received from conferencing units. In the embodiment where the method is performed on audio received from another participant, the method may be performed before the audio of all other participant locations are combined and/or after they are combined. Thus, the method may be performed for audio of individual participant locations and/or for combined audio of all or a subset of the participant locations. The method may be performed by various endpoints or conferencing units, but may also be performed by transceivers, MCUs, transcoders, or any other intervening equipment between endpoints of the conference, as desired.

Note that the above method may be performed in response to participant input. For example, the first participant (and/or another participant) may activate the filtering process to filter auxiliary audio, and the detection and filtering performed in 406 and 408 may be performed in response to that participant input. Thus, the method described above may be performed in response to participant input. However, in further embodiments, the method may be performed automatically, without requiring any activation from a participant.

Additionally, the user may further be able to set how “aggressive” the filter may be. For example, the user may have be able to set how much filtering is performed, e.g., in a low to high manner. Thus, the user may request that the filter be more aggressive about filtering out auxiliary noise, with the potential cost of losing desired audio, or may request that the filter be more lax, with the potential cost of hearing more auxiliary audio. These users settings (and/or any described herein) may be set by the local participant (e.g., where the sounds are coming from) and/or the remote participant (e.g., who is hearing the sounds remotely). Additionally, these settings may vary from participant to participant, even within the same videoconference. Thus, if a first user has aggressive filtering turned on, he may hear less auxiliary audio (and potentially less vocal audio) for a participant than a second user that has lax filtering turned on will hear from the same participant.

Note further that the method described above may further be extended to video in a videoconference, where auxiliary video is removed from video signals corresponding to the first participant.

### ADVANTAGES

The method described above has substantial advantages over the prior publication identified in the Description of the Related Art. More specifically, in the prior method, if a user was using an input device, the microphone was simply muted, and therefore, the user could not participate in the conference while using the input device. Alternatively, the user could override the muting, but both the desired vocal audio and the undesired input audio would be provided to all the other participants in the conference.

Accordingly, the method described herein provides a much better solution, where the user can freely use input devices and participate in the conference without causing other participants to be forced to listen to the undesired auxiliary audio. In the present method, no muting is required, and correspondingly, the participant does not have to worry about overriding such muting or bothering other participants when, for example, typing notes of the conference, even when the participant needs to vocally participate in the conference. Thus, the present method provides many benefits over the prior art.

Embodiments of a subset or all (and portions or all) of the above may be implemented by program instructions stored in a memory medium or carrier medium and executed by a processor. A memory medium may include any of various types of memory devices or storage devices. The term “memory medium” is intended to include an installation medium, e.g., a Compact Disc Read Only Memory (CD-ROM), floppy disks, or tape device; a computer system memory or random access memory such as Dynamic Random Access Memory (DRAM), Double Data Rate Random Access Memory (DDR RAM), Static Random Access Memory (SRAM), Extended Data Out Random Access Memory (EDO RAM), Rambus Random Access Memory (RAM), etc.; or a non-volatile memory such as a magnetic media, e.g., a hard drive, or optical storage. The memory medium may comprise other types of memory as well, or combinations thereof. In addition, the memory medium may be located in a first computer in which the programs are executed, or may be located in a second different computer that connects to the first computer over a network, such as the Internet. In the latter instance, the second computer may provide program instructions to the first computer for execution. The term “memory medium” may include two or more memory mediums that may reside in different locations, e.g., in different computers that are connected over a network.

In some embodiments, a computer system at a respective participant location may include a memory medium(s) on which one or more computer programs or software components according to one embodiment of the present invention may be stored. For example, the memory medium may store one or more programs that are executable to perform the methods described herein. The memory medium may also store operating system software, as well as other software for operation of the computer system.

Further modifications and alternative embodiments of various aspects of the invention may be apparent to those skilled in the art in view of this description. Accordingly, this description is to be construed as illustrative only and is for the purpose of teaching those skilled in the art the general manner of carrying out the invention. It is to be understood that the forms of the invention shown and described herein are to be taken as embodiments. Elements and materials may be substituted for those illustrated and described herein, parts and processes may be reversed, and certain features of the invention may be utilized independently, all as would be apparent to one skilled in the art after having the benefit of this description of the invention. Changes may be made in the elements described herein without departing from the spirit and scope of the invention as described in the following claims.

What is claimed is:

1. A non-transitory memory medium comprising program instructions for performing a videoconference, wherein the program instructions are executable by a processor to:
receive audio during the videoconference, wherein the audio comprises vocal audio from a first participant, and wherein the audio further comprises auxiliary audio that is not vocal audio from the first participant, wherein the auxiliary audio results from use of a computer input device at the location;
filter the audio to remove the auxiliary audio from the audio, wherein said filtering produces filtered audio; and
provide the filtered audio.

2. The non-transitory memory medium of claim 1, wherein the audio is received by a videoconferencing unit of the first participant, and wherein the filtered audio is provided over a network to other participant locations of the videoconference by the videoconferencing unit of the first participant.

3. The non-transitory memory medium of claim 1, wherein the audio is received over a network by a videoconferencing unit of a second participant, wherein said filtering and said providing is performed by the videoconferencing unit of the second participant.

4. The non-transitory memory medium of claim 1, wherein the computer input device comprises a computer keyboard.

5. The non-transitory memory medium of claim 1, wherein the computer input device comprises a computer mouse.

6. The non-transitory memory medium of claim 1, wherein the program instructions are further executable to:
determine that the audio comprises the auxiliary audio, wherein said filtering is performed based on said determining.

7. The non-transitory memory medium of claim 4, wherein said determining comprises:
comparing the audio to prerecorded auxiliary audio to determine if the audio comprises the auxiliary audio.

8. The non-transitory memory medium of claim 5, wherein the prerecorded auxiliary audio comprises prerecorded audio of the computer input device.

9. The non-transitory memory medium of claim 1, wherein said filtering uses an adaptive filter.

10. The non-transitory memory medium of claim 1, wherein the program instructions are further executable to:
receive input requesting said filtering, wherein the input is for allowing the first participant to provide the vocal audio and use the computer input device at the same time, wherein the input is from the first participant, and wherein said filtering is performed in response to the input.

11. A method for performing a videoconference, comprising:
receiving audio during the videoconference, wherein the audio comprises vocal audio from a first participant, and wherein the audio further comprises auxiliary audio that is not vocal audio from the first participant, wherein the auxiliary audio results from use of a computer input device at the location;
filtering the audio to remove the auxiliary audio from the audio, wherein said filtering produces filtered audio; and
providing the filtered audio.

12. The method of claim 11, wherein the audio is received by a videoconferencing unit of the first participant, and wherein the filtered audio is provided over a network to other participant locations of the videoconference by the videoconferencing unit of the first participant.

13. The method of claim 11, wherein the audio is received over a network by a videoconferencing unit of a second participant, wherein said filtering and said providing is performed by the videoconferencing unit of the second participant.

14. The method of claim 11, wherein the computer input device comprises a computer keyboard.

15. The method of claim 11, wherein the computer input device comprises a computer mouse.

16. The method of claim 11, further comprising:
determining that the audio comprises the auxiliary audio, wherein said filtering is performed based on said determining.

17. The method of claim 14, wherein said determining comprises:
comparing the audio to prerecorded auxiliary audio to determine if the audio comprises the auxiliary audio.

18. The method of claim 15, wherein the prerecorded auxiliary audio comprises prerecorded audio of the computer input device.

19. The method of claim 11, further comprising:
receiving input requesting said filtering, wherein the input is for allowing the first participant to provide the vocal audio and use the computer input device at the same time, wherein the input is from the first participant, and wherein said filtering is performed in response to the input.

20. A system for performing a videoconference, comprising:
a processor;
a memory medium coupled to the processor, wherein the memory medium stores program instructions executable by the processor to implement:
receiving audio during the videoconference, wherein the audio comprises vocal audio from a first participant, and wherein the audio further comprises auxiliary audio that is not vocal audio from the first participant, wherein the auxiliary audio results from use of a computer input device at the location;
filtering the audio to remove the auxiliary audio from the audio, wherein said filtering produces filtered audio; and
providing the filtered audio.
